(19) United States
(12) Patent Application Publication
(10) Pub. No.: US 2020/0078870 A1
(43) Pub. Date: Mar. 12, 2020

(54) DRILL CHUCK

(71) Applicant: ZHEJIANG SANOU MACHINERY CO. LTD., Luqiao Taizhou (CN)

(72) Inventor: Xiangyu LI, Luqiao Taizhou (CN)

(21) Appl. No.: 16/564,973

(22) Filed: Sep. 9, 2019

(30) Foreign Application Priority Data
Sep. 12, 2018 (CN) 201811060311.1

(51) Int. Cl. B23B 31/12

(52) U.S. Cl. CPC B23B 31/1238

(57) ABSTRACT

A drill chuck is disclosed in the present invention. A ring body that can be expanded and deformed outwardly and recovered inwardly is disposed between the ring of steel balls at the back of the nut and the rotary sleeve, the ring body has a portion abutted by steel balls and an outer portion engaged with the rotary sleeve or a part fixedly coupled to the rotary sleeve after the ring body is expanded and deformed outwardly, there is a gap between the outer portion and the rotary sleeve or the part fixedly coupled to the rotary sleeve when the drill chuck is not working, and the gap is within the deformation range of the ring body, a steel ball pushing structure that relies on the back thrust generated when the drill chuck is working is formed between the nut and the support structure, such that the steel balls can push outwardly to expand and deform the ring body outwardly. The present invention has a simple structure, and can resist inertia and prevent loosening of the rotary sleeve on the basis of the original structure of the drill chuck, such that the drill chuck can maintain the original working state during the drilling work.

### FIELD OF THE INVENTION

The present invention relates to a drill chuck, and more particularly to a keyless drill chuck.

### BACKGROUND OF THE INVENTION

The drill chuck has a drill body, a clamping jaw and a nut, the nut is connected with the clamping jaw via threaded connection. The keyless drill chuck is provided with a rotary sleeve, and the rotary sleeve is directly connected with or connected with the nut through a connecting structure. By manually operating the rotary sleeve and rotating the nut to drive the clamping jaw to move forwardly or backwardly, the drill bit is clamped or loosened by the clamping jaw. When the drill bit is clamped for drilling work in the actual use, the rotary sleeve may be loosened due to inertia, etc. once the inertial motion occurs, resulting in the loosening of the drill bit or failure of the locking state of the drill chuck.

### SUMMARY OF THE INVENTION

An object of the present invention is to provide a drill chuck capable of resisting inertia and looseness of the rotary sleeve during work. In order to achieve this object, the present invention adopts the following technical solutions:

A drill chuck, comprising a rotary sleeve, a drill body, a nut and a clamping jaw, wherein the nut is connected with the clamping jaw via threaded connection, the rotary sleeve is directly connected with or connected with the nut through a connecting structure, the drill body is provided with an inclined clamping jaw hole for the clamping jaw to slide back and forth along the clamping jaw hole, a ring of steel balls are cushioned around the drill body at the back of the nut, and a support structure is disposed behind the ring of steel balls; wherein a ring body that can be expanded and deformed outwardly and recovered inwardly is disposed between the ring of steel balls and the rotary sleeve, the ring body has a portion abutted by steel balls, and an outer portion engaged with the rotary sleeve or a part fixedly coupled to the rotary sleeve after the ring body is expanded and deformed outwardly, there is a gap between the outer portion and the rotary sleeve or the part fixedly coupled to the rotary sleeve when the drill chuck is not working, and the gap is within the deformation range of the ring body, a steel ball pushing structure that relies on the back thrust generated when the drill chuck is working is formed between the nut and the support structure, such that the steel balls can push outwardly to expand and deform the ring body outwardly.

Further, the pushing structure comprises a bevel inclined forwardly and outwardly provided at the rear end surface of the nut or/and a bevel of the support structure inclined backwardly and outwardly.

Further, the selection range of the support structure includes a gasket disposed behind the steel ball and a step disposed in the middle of the drill body.

Further, the selection range of the ring body includes a spacing ring in the periphery of the ring of steel balls.

Further, the ring of steel balls is stuck in the ring frame, and the selection range of the ring body includes a portion of the ring frame located outside of the steel balls facing toward the rotary sleeve.

Further, the steel balls wrap the grease for the bearing.

Further, the ring body is a plastic ring body or a thin steel ring body or an iron ring body.

Further, the ring body is between the rear end surface of the nut and the support structure.

Further, the selection of the outer portion includes a surface and a tooth, and the surface includes a glossy surface and a matte surface, and the matte surface may be a surface having regular or irregular grains, a rough surface, etc.

With the technical solutions herein, the present invention has a simple structure, and can resist inertia and prevent loosening of the rotary sleeve on the basis of the original structure of the drill chuck, such that the drill chuck can maintain the original working state during the drilling work.

### BRIEF DESCRIPTION OF THE DRAWINGS

FIG. 1 is a cross-sectional view according to Example 1 of the present invention.

FIG. 2 is an exploded view according to Example 1 of the present invention.

FIG. 3 is a schematic view of a nut according to Example 1 of the present invention.

FIG. 4 is a schematic view of a steel ball and a ring frame assembly part according to Example 1 of the present invention.

FIG. 5 is a cross-sectional view according to Example 2 of the present invention.

FIG. 6 is a schematic view of a gasket according to Example 2 of the present invention.

FIG. 7 is a cross-sectional view according to Example 3 of the present invention.

FIG. 8 is a schematic view of a drill body according to Example 3 of the present invention.

FIG. 9 is a cross-sectional view according to Example 4 of the present invention.

FIG. 10 is an exploded view according to Example 4 of the present invention.

FIG. 11 is a cross-sectional view according to Example 5 of the present invention.

FIG. 12 is a cross-sectional view according to Example 6 of the present invention.

FIG. 13 is a schematic view of a drill body according to Example 6 of the present invention.

### DETAILED DESCRIPTION

### Example 1

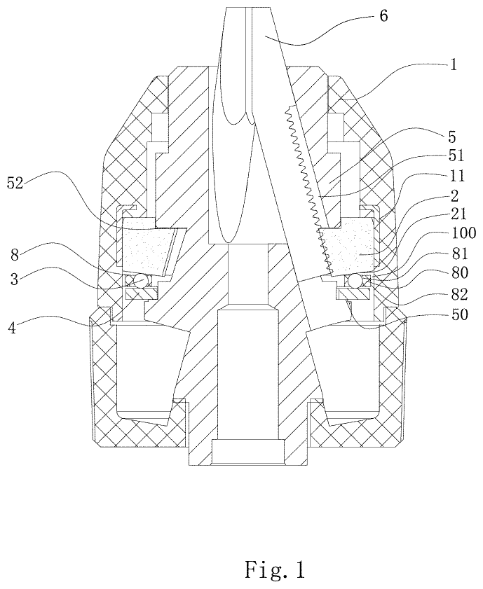

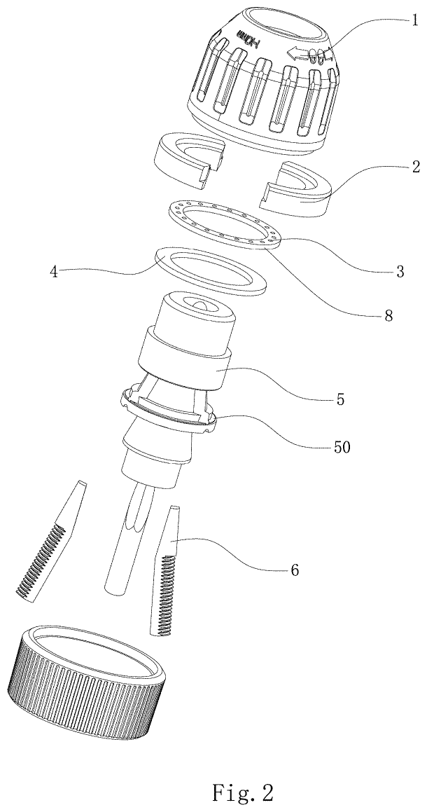

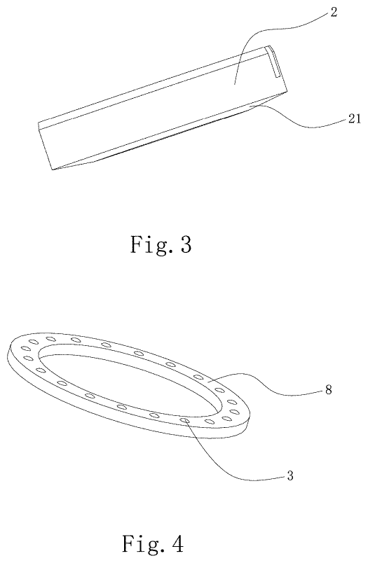

Referring to FIGS. 1 to 4, the drill chuck provided herein, comprising a rotary sleeve 1, a drill body 5, a nut 2 and a clamping jaw 6, wherein the nut 2 is connected with the clamping jaw 6 via threaded connection, the rotary sleeve 1 is inlaid with a metal sleeve 11 which is wrapped outside the nut 2 and is connected with the nut 2 in an interference fit. The drill body is provided with an inclined clamping hole 51, and the clamping jaw 6 passes through the clamping jaw hole 51 and can slide back and forth along the clamping jaw hole 51 driven by the nut 2.

A ring of steel balls 3 are cushioned around the drill body 5 at the back of the nut 2, a step 50 is provided in the middle of the drill body 5, and a washer 4 is provided above the step in the middle, which constitutes a support structure behind the steel balls.

The drill chuck is provided with a ring frame 8 of the ring of steel balls 3, and the ring frame 8 is between the rear end surface of the nut 2 and the support structure. The steel balls 3 are stuck in the ring frame 8, and the steel balls 3 wrap the grease for the bearing. The ring frame 8 is a plastic body, the portion of the ring frame located outside of the steel balls facing toward the rotary sleeve constitutes a ring body 80 which can be outwardly expanded and deformed and recovered inwardly. The plastic ring body 80 can be expanded outwardly to a certain extent when subjecting to the extrusion thrust of the steel balls outwardly, and when the outward extrusion thrust disappears, it can be recovered inwardly.

The inner side surface 81 of the plastic ring body 80, that is, the side facing toward the steel balls, is a portion abutted by the steel balls 3. The outer side surface 82 of the plastic ring body 80 is a surface that is engaged with the rotary sleeve 1 after the ring body is expanded and deformed outwardly. In the normal state, there is a gap between the surface 82 and the rotary sleeve or the portion fixedly coupled to the rotary sleeve when the drill chuck is not working, and the gap 100 is within the deformation range of the ring body 80. The rear end surface of the nut 2 is provided with a bevel 21 that is inclined outwardly and outwardly, and the bevel 21 and the support structure form an annular expansion port. When the drill chuck is drilling forwardly, the nut is subjected to a back thrust, and the expansion port can push the steel balls outwardly such that the steel balls can push the ring body 80 outwardly to expand and deform outwardly. The deformation makes the outer side surface 82 of the ring body 80 to be squeezed tightly with the rotary sleeve, and when the inertia occurs, it has a positioning and retaining effect on the rotary sleeve to resist the inertia and prevent loosening of the rotary sleeve through a simple and effective manner, such that the drill chuck can maintain the original working state during the drilling work.

The metal sleeve 11 may not be inlaid in the rotary sleeve 1, and may be connected to the rotary sleeve 1 by a connection such as a keyway. The nut 2 may be composed of two halves as in the present embodiment. When mounting, the two halves are first placed in a nut groove on the drill body, and then the two halves are connected to the entire nut 2 through the metal sleeve 11. The nut groove is constituted by a middle step 50 and a front groove wall 52 on the drill body 5, and the front groove wall 52 has a limiting effect in the front of the nut 2. The drill body may not be provided with the front groove wall 52, and the part such as a sleeve or a rotary sleeve fixed to the front of the drill body 5 play a role of limiting in the front of the nut 2.

The rotary sleeve may cover the position between the nut rear end surface and the step 50 in the middle of the drill body in the axial direction, or may not cover the position, but the ring body which can be expanded and deformed outwardly and recovered inwardly is extended correspondingly for the above cooperation; or there is a part fixedly coupled to the rotary sleeve, for example the metal sleeve 11, and the ring body and the metal sleeve can perform the above cooperation.

The ring body that can be expanded and deformed outwardly and recovered inwardly may also be a separate ring that surrounds the ring of steel balls 3 between the rear end surface of the nut and the support structure, or surrounded by the ring member on the periphery of the ring frame 8, and the steel balls 3 are abutted against the ring member by means of the ring frame 8.

### Example 2

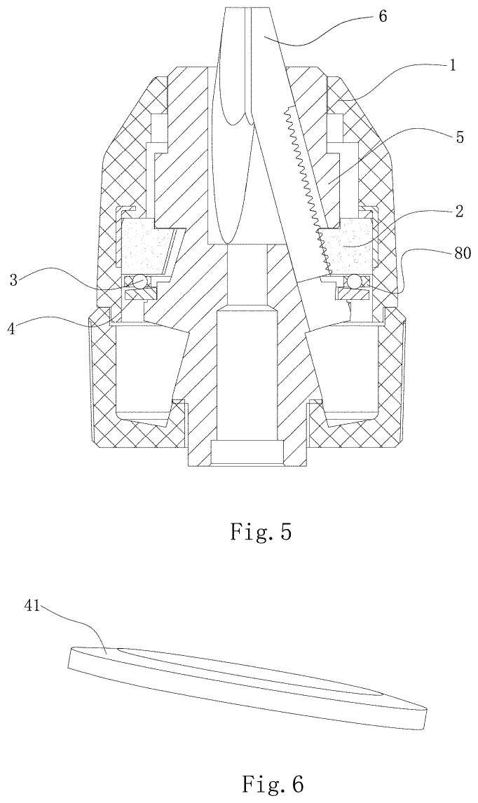

Referring to FIGS. 5 to 6, in the present embodiment, the washer 4 is provided with a bevel 41 which is inclined backwardly and outwardly. The nut 2 may be set to a bevel 21 in the first embodiment or the bevel may not be set. The other structures of this embodiment are the same as those of the first embodiment. In FIGS. 5-6, the components same as those of the first embodiment are denoted by the same reference numerals as those of FIGS. 1-4, and are not described herein again.

This embodiment can achieve the technical effect obtained in the first embodiment.

### Example 3

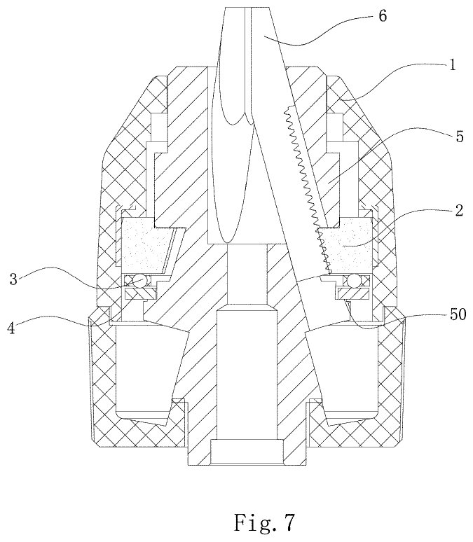

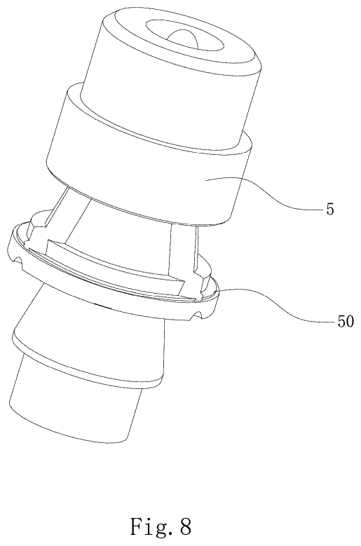

Referring to FIGS. 7 to 8, in the present embodiment, the outer corner portion of the step 50 in the middle of the drill body 5 is processed and removed, so that the washer 4 has more suspension portions in the middle step 50. When the drill chuck is working and drilling forward, the nut 2 will be subjected to the back thrust, such that the steel balls will press the washer backwards, and the washer will have a certain degree of recoverable backward and outward tilting deformation with the edge of the middle step 50 having notch angle as a fulcrum, thus forming an expanded steel ball pushing structure with the nut rear end surface to push the steel balls outwardly, so that the steel balls 3 can push the ring body 80 outwardly to expand and deform outwardly, and the deformation makes the outer side surface 82 of the ring body 80 to be squeezed tightly with the rotary sleeve, to achieve the technical effect of the first embodiment.

The structure of the middle step 50 is also applicable to the embodiments 1 and 2, wherein the drill body 5 in FIG. 1-6 has been disposed as the outer corner portion of the middle step 50, which is processed and removed (of course, when the nut rear end surface has already been disposed with bevel that is inclined forwardly and outwardly and/or the washer is disposed with bevel that is inclined backwardly and outwardly, the outer corner portion of the middle step 50 may not be processed and removed).

The other structures of this embodiment are the same as those of the first embodiment. In FIGS. 7-8, the components same as those of the first embodiment are denoted by the same reference numerals as those of FIGS. 1-4, and are not described herein again. This embodiment can achieve the technical effect obtained in the first embodiment.

### Example 4

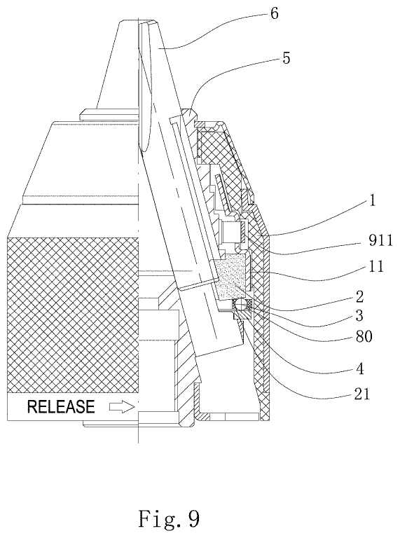

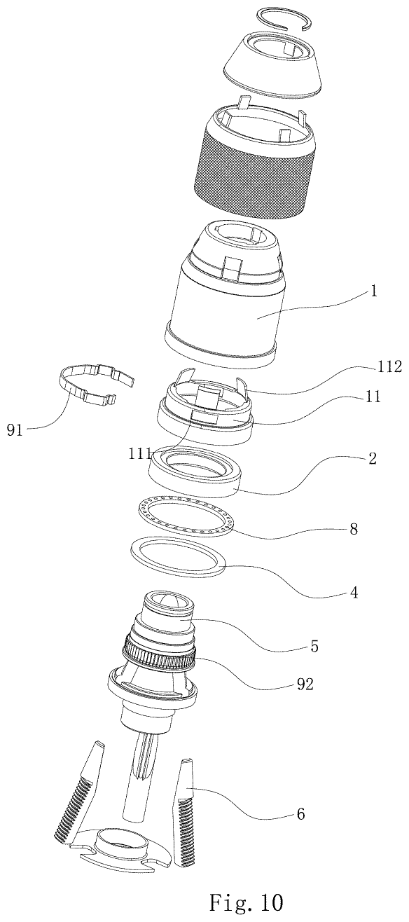

Referring to FIGS. 9-10, this embodiment basically adds a self-locking structure on the basis of the first embodiment. The pushing structure in this embodiment is the same as that in the first embodiment, and will not be described here again. In FIGS. 9-10, the components same as those of the first embodiment are denoted by the same reference numerals as those of FIGS. 1-4.

In this embodiment, the self-locking structure adopts a spring piece 91 and a gear ring 92 that cooperates with the locking end of the spring piece 91. The ring gear 92 can be disposed on the drill body 5 and a part or a portion that is fixedly connected to the drill body 5 such as a sleeve body. The metal sleeve 11 is connected to the nut 2 in an interference fit as that in the first embodiment, but is not inlaid in the rotary sleeve 1. The metal sleeve 11 extends a connecting portion at the front portion thereof, and the connecting portion includes a hole 111 connected to the spring piece and a groove 112 (or a key) connected to the rotary sleeve, and the spring piece is connected to the hole 111 by a middle portion thereof. The inside of the rotary sleeve has a cam surface that is in engagement with the spring piece to control the insertion of the spring piece locking end into the ring gear 92 to cause the drill chuck to enter the self-locking state and to disengage the ring gear, such that the drill chuck enters the unlocked state. There is a first connecting groove connected with the middle portion 911 of the spring piece in the unlocked state and a second groove connected with the middle portion 911 of the spring piece in the self locking state in the inner wall of the rotary sleeve. There is a key (or groove) that is in engagement with the groove 112 (or the key) in the inner wall of the rotary sleeve, and such engagement is an intermittent engagement of transposition, that is, when the drill chuck is stored in the unlocked state, the rotary sleeve drives the nut to rotate through the connection relationships between the first connecting groove and the middle convex portion, between the spring piece and the metal sleeve, between the metal sleeve and nut. When the drill chuck enters the self locking state, the rotary sleeve rotates at a certain angle with respect to the metal sleeve. At this time, the groove wall (or key) of the groove 112 is in contact with the key (or the groove wall of the groove) of the inner wall of the rotary sleeve which is engaged with the groove 112 (or the key) in the direction of rotation, and the connection relationship drives the nut to rotate, and at this time, the connection relationship between the first connecting groove of the rotary sleeve and the bulge in the middle of the spring piece is switched to the connection relationship between the second connecting groove and the bulge in the middle of the spring piece, to form a state locking function of maintaining the self-locking state when the drill chuck is working.

As described above, when the drill chuck is punching forward, the nut 2 is subjected to the back thrust, and the steel ball 3 is pushed outwardly by the steel ball pushing structure, such that the steel ball 3 can push the ring body 80 outwardly to expand and deform outwardly, and the deformation makes the outer side surface 82 of the ring body 80 to be squeezed tightly with the rotary sleeve, and when the inertia occurs, it has a positioning and retaining effect on the rotary sleeve to resist the inertia and prevent loosening of the rotary sleeve, such that the drill chuck can maintain the original working state during the drilling work.

### Example 5

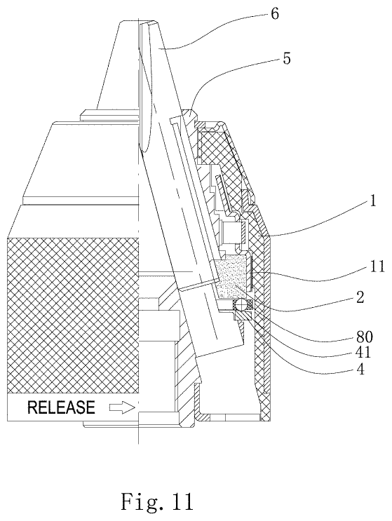

Referring to FIG. 11, this embodiment basically adds a self-locking structure on the basis of the second embodiment. The pushing structure in this embodiment is the same as that in the second embodiment. The self-locking structure is the same as that in the fourth embodiment, and will not be described again herein. In FIG. 11, the components same as those of the second and fourth embodiments are denoted by the same reference numerals.

### Example 6

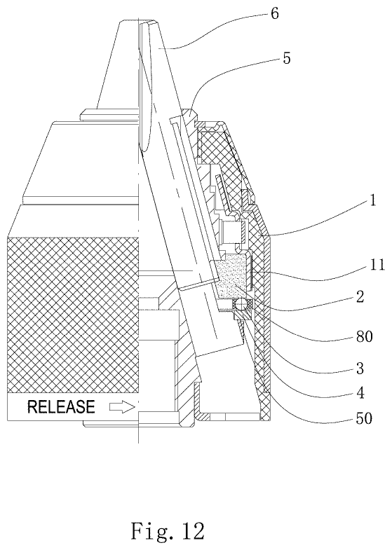

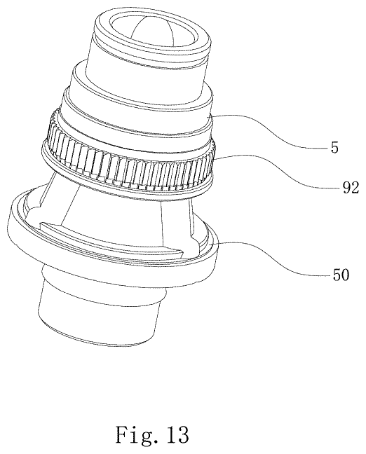

Referring to FIGS. 12 and 13, this embodiment basically adds a self-locking structure on the basis of the third embodiment. The pushing structure in this embodiment is the same as that in the third embodiment. The self-locking structure is the same as that in the fourth embodiment. In FIG. 12, the components same as those of the third and fourth embodiments are denoted by the same reference numerals.

Similarly, the structure of the middle step 50 in the embodiments 3 and 6 is also applicable to the embodiments 4 and 5, wherein the drill body 5 in FIGS. 10 and 11 has been disposed as the outer corner portion of the middle step 50, which is processed and removed (of course, when the nut rear end surface has already been disposed with bevel that is inclined forwardly and outwardly and/or the washer is disposed with bevel that is inclined backwardly and outwardly, the outer corner portion of the middle step 50 may not be processed and removed).

The foregoing description is merely the specific embodiments of the present invention, but the structural features of the present invention are not limited thereto, and any changes or modifications made by those skilled in the art within the scope of the present invention should fall into the scope of protection of the present invention.

1. A drill chuck, comprising a rotary sleeve, a drill body, a nut and a clamping jaw, wherein the nut is connected with the clamping jaw via threaded connection, the rotary sleeve is directly connected with or connected with the nut through a connecting structure, the drill body is provided with an inclined clamping jaw hole for the clamping jaw to slide back and forth along the clamping jaw hole, a ring of steel balls are cushioned around the drill body at the back of the nut, and a support structure is disposed behind the ring of steel balls; wherein a ring body that can be expanded and deformed outwardly and recovered inwardly is disposed between the ring of steel balls and the rotary sleeve, and the ring body has a portion abutted by steel balls, the ring body further has an outer portion, and the outer portion is engaged with the rotary sleeve after the ring body is expanded and deformed outwardly, or the outer portion is engaged with a part fixedly coupled to the rotary sleeve after the ring body is expanded and deformed outwardly;
there is a gap between the outer portion and the rotary sleeve when the drill chuck is not working or there is a gap between the outer portion and the part fixedly coupled to the rotary sleeve when the drill chuck is not working, and the gap is within the deformation range of the ring body; a steel ball pushing structure that relies on the back thrust generated when the drill chuck is working is formed between the nut and the support structure, such that the steel balls can push outwardly to expand and deform the ring body outwardly.

2. The drill chuck according to claim 1, wherein the pushing structure comprises a bevel inclined forwardly and outwardly provided at the rear end surface of the nut or/and a bevel of the support structure inclined backwardly and outwardly.

3. The drill chuck according to claim 1, wherein the selection range of the support structure includes a gasket disposed behind the steel ball and a step disposed in the middle of the drill body.

4. The drill chuck according to claim 1, wherein the selection range of the ring body includes a spacing ring in the periphery of the ring of steel balls.

5. The drill chuck according to claim 1, wherein the ring of steel balls is stuck in the ring frame, and the selection range of the ring body includes a portion of the ring frame located outside of the steel balls facing toward the rotary sleeve.

6. The drill chuck according to claim 1, wherein the steel balls wrap the grease for the bearing.

7. The drill chuck according to claim 1, wherein the ring body is a plastic ring body or a thin steel ring body or an iron ring body.

8. The drill chuck according to claim 1, wherein the ring body is between the rear end surface of the nut and the support structure.

9. The drill chuck according to claim 1, wherein the selection of the outer portion includes a surface and a tooth, and the surface includes a glossy surface and a matte surface.
